(19) United States
(12) Patent Application Publication
(10) Pub. No.: US 2013/0087043 A1
(43) Pub. Date: Apr. 11, 2013

(54) Device and Method for Removing Volatile Substances From a Liquid Mixture

(71) Applicant: Matthias Enzenhofer, Simmozheim (DE)

(72) Inventor: Matthias Enzenhofer, Simmozheim (DE)

(21) Appl. No.: 13/697,461

(22) PCT Filed: May 12, 2011
(86) PCT No.: PCT/EP2011/057697

§ 371 Date: Dec. 14, 2012

(30) Foreign Application Priority Data
May 12, 2010 (DE) 20 2010 006 567.4

(51) Int. Cl. B01D 1/06

(52) U.S. Cl. CPC B01D 1/065
USPC 95/257; 96/202

(57) ABSTRACT

A device comprises a desorber unit having a carrier arrangement with an inlet and an outlet for the liquid mixture, wherein the cant-lien arrangement is designed such that the liquid mixture can be guided between inlet and outlet via a number of carriers, e.g., profiles, tubes or pipes, and form a flowing liquid film on the surface of the carriers, and a gas control with a gas inlet and a gas outlet, between which the gas can sweep past the liquid film, such that the at least one volatile substance can pass over from the liquid mixture into the gas. A condensation unit with a gas inlet connects to the gas outlet of the desorber unit. A heat exchanger cools gas passed through it, which comes from the desorber unit, such that the at least one volatile substance can be condensed from the gas. A fan is incorporated into a gas connection between the desorber unit and the condensation unit such that a gas stream through the device can be produced.

### BACKGROUND

The invention relates to a device and a method to remove volatile substances from a liquid mixture.

Removing volatile substances from a liquid mixture can be a procedural step in a method for removing volatile substances e.g. from exhaust air such as exhaust air in a painting company. In such a method at first the volatile substances can be removed from the exhaust air in a first step using a liquid absorbent Ina second step the removed substances can be recovered from the absorbent then.

The first step can be carried out e.g. by an air cleaning device according to WO2004/008034. Such an air cleaning device can remove volatile substances from air by means of a wet filter device, in which the air is guided in cross flow past a plurality of filter elements containing woven plastic tubes, which are moistened with a film of an absorbent liquid flowing down the tube surfaces. The volatile substances dissolve in the absorbent and are removed from the air thereby. In order to maintain the cleaning function of the device, the absorbent must be replaced when it has reached a certain content of liquid substances.

The required replacement of the absorbent can be avoided by removing the volatile substances from the absorbent again in the second step such that a recovery of the volatile substances becomes possible as well.

Removing volatile substances from a liquid (such as the absorbent) can be carried out conventionally for example by distillation. For this purpose a liquid mixture containing at least one volatile substance besides a non-volatile liquid is heated such that mainly the volatile substance evaporates, while the non-volatile liquid remains. The evaporated volatile substance can be recovered as a liquid from the vapour phase by cooling. Disadvantages of such a distillation are the required time and energy expenditure.

### SUMMARY

A desorber unit by means of which the method can be implemented, comprises a liquid supply and a liquid outlet for a liquid such as an absorbent as well as a gas supply and a gas outlet. The absorbent is guided across the carriers such that an absorbent film (which can comprise several individual films) can effect an exchange of substances with the gas guided past, in which by suitable process conditions a desorption of the volatile substance(s) dissolved in the absorbent, i.e. a removal of the volatile substance from the absorbent is effected, wherein the volatile substance(s) passes over into the gas and is removed with it. In this the absorbent and/or the gas can be heated such that the exchange of substances can be carried out at an elevated temperature to achieve an improved removal of the volatile substance(s). As an alternative or in addition, an improved removal can be achieved using reduced pressure. When required, the absorbent can be subjected to multiple subsequent desorption steps either by using multiple desorber units arranged in series and/or by repeated passing (circulation) of the absorbent through the same desorber unit.

The gas leaving the desorber unit is guided to a condensation device. The volatile substance(s) contained in the gas are partially removed from the gas therein by at least partial condensation such that gas with a reduced concentration of the volatile substance is obtained. This gas can be guided back into the desorber unit subsequently such that a closed air circuit can be implemented without producing any further exhaust air. The gas is moved in the circuit by a fan. As the temperature difference between the desorption temperature and the condensation temperature can be maintained lower as in a corresponding distillation, reduced energy consumption can be achieved.

The absorbent discharged from the desorber unit, from which the volatile substance(s) was removed, can be supplied e. g. to an air cleaning device according to WO 2004/008034 again such that a closed absorbent circuit can be implemented as well. In this all processes can be carried out continuously.

Thus, such a combination of air cleaning device, desorber unit and condensations device can be used to clean exhaust gas or exhaust air from volatile substances, wherein the volatile substances can be recovered by the closed absorbent and gas circuits (related to the gas required for the desorber unit) without producing any waste material.

### BRIEF DESCRIPTION OF THE DRAWINGS

FIG. 1 shows a functional diagram of an exemplary desorption part of a solvent separation and recovery system; and

FIG. 2 shows the schematic design of an exemplary carrier arrangement with fixing devices.

### DETAILED DESCRIPTION

The term ‘remove’ for the purposes of the invention does not necessarily imply a complete removal of the volatile substance(s) from the absorbent, but also includes a reduction of the content of the volatile substance. The degree of removal depends on many parameters and is preferably at least 50%, more preferably at least 70%, still more preferably at least 90% per desorber unit. In order to increase the total degree of removal of the volatile substance(s) the absorbent can be guided through multiple desorber units in series and/or several times repeatedly circulated through the same desorber unit.

Unless otherwise defined percentages relate to mass.

A method for removing at least one volatile substance from a liquid mixture containing a liquid besides the at least one volatile substance, comprises the following steps:
a) guiding a gas past carriers moistened with the liquid mixture such that at least part of the at least one volatile substance passes over from the liquid mixture into the gas,
b) condensing the at least one volatile substance from the gas obtained in step a) by changing the pressure or temperature of the obtained gas such that at least part of the at least one volatile substance is separated from the gas and the concentration of the at least one volatile substance in the gas is reduced, and
c) returning the gas obtained in step b) to step a).

It is preferred to use air as the gas. Alternatively also other gases such as nitrogen can be used.

E.g. profiles, tubes or pipes can be used as the carrier. Woven plastic tubes are preferably used, which preferably comprise thermoplastics such as polyester, polyamide, polyethylene, polypropylene. Particularly suitable is polyester. The woven plastic tubes can be formed from one or multiple filaments, preferably from multiple filaments. The mechanical stability of the woven plastic tubes is preferably improved by thermal treatment resulting in a partial fusion or sintering of the filaments possibly with shrinking (the production of such tubes is described in DE 42 33 827 C2 for example). They remain porous, however, such that an advantageous exchange of liquids occurs between the interior and the exterior of the woven plastic tubes during operation of the device, which lowers the flow speed of the liquid film and also effects a thorough mixing of the liquid and self-cleaning of the carrier. Instead of whole tubes also tubes divided lengthwise in halves can be used for example, which also have a semi-circular cross-section. The carriers preferably have an outer diameter of at least 2 cm, more preferably of at least 1 cm, still more preferably of at least 6 mm. The length of the carriers is preferably at least 10 times, more preferably at least 30 times the diameter. It is preferred to use a plurality of carriers, which are arranged in parallel equally distanced (the distance is preferably 1.5 to 2.5 times the outer diameter of the support) adjacent each other in a straight or curved row, wherein preferably e.g. 10 to 20 of such rows are arranged behind each other, preferably laterally displaced by half a distance, i.e. covering gaps, in parallel to each other. The gas stream is guided preferably perpendicularly to these rows, i.e. in cross flow such that it sweeps around the liquid film on the carrier surfaces as completely as possible, and can be produced by a fan and guided and distributed by air guiding elements. In this the speed of the air stream should not be selected too high to avoid the creation and entrainment of liquid droplets.

The liquid film on the carrier surface is preferably a falling film, i.e. the liquid moves from top to bottom due to gravity. Therefore the carriers are inclined in their longitudinal extension with regard to the horizontal, preferably arranged at least substantially vertically.

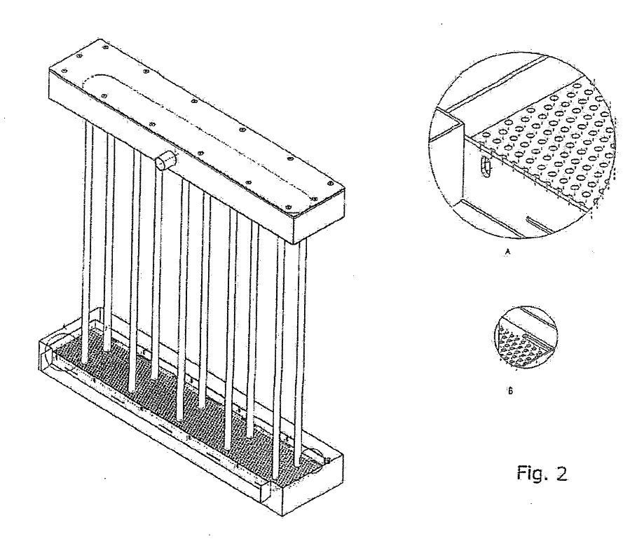

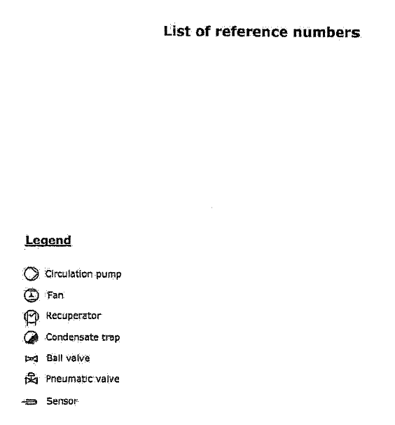

FIG. 2 shows exemplarily (for the sake of clarity only few carriers are illustrated), how the individual carriers can be preferably held at the top and the bottom by perforated plates each at their top and bottom ends, such as by gluing, welding or clamping, and kept tensioned thereby. The top perforated plate also serves to supply and distribute liquid to the individual supports and contains only holes to accommodate the carriers. The outflow of the liquid can occur through the bottom perforated plate, which can comprise further holes in addition to the holes for accommodating the carriers, which enable the outflow of the liquid flowing down on the outside of the carrier.

Each liquid can serve as the absorbent, which is able to absorb the respective volatile substance(s) and discharge (desorb) it/them again. It is advantageous in most cases, if the vapour pressure of these liquids is not too high, most of all the vapour pressure should be in general clearly below the vapour pressure of the volatile substance. Therefore the boiling point of the absorbent should be preferably at least 99° C., more preferably at least 150° C., still more preferably at least 200° C. Suitable absorbents are e.g. water; solutions, preferably aqueous solutions of cyclodextrins (e. h. a-, β- or γ-cyclodextrins) or cycloclextrin derivatives (e.g. CAVASOL® W6 HP of the company Wacker Chemie AG); liquid paraffins; mineral oils such as spindle oil (e.g. ISO-VG 8, 10 or 46 of the company LINOCEM GmbH & Co. KG); ethylene glycol; glycerine; polyethylene glycol; ethoxylates of alcohols, amines or amides and acids (e. g. Lutensol® of the company BASF SE); and polyethylene glycol dialkyl ether ((z. B. Genosorb® of the company Clariant GmbH, in particular, Genosorb® 300, 1753 or 1843).

Volatile substances for the purposes of the invention include all substances having such a vapour pressure at room temperature that verifiable amounts can pass over into the gas phase (air), e.g. volatile organic compounds like solvents such as aliphatic and aromatic hydrocarbons, alcohols, aldehydes, ketones, ethers and esters. Depending on the respective volatile substance a suitable absorbent can be selected, wherein especially suitable absorbents can be easily found by preselection based on conventional criteria (similar chemical substances, dipole moments, polarizabilities) in consideration of a sufficient difference of the vapour pressures and experimental confirmation of suitability.

The condensation of the volatile substance in the condensation device can be carried out preferably by cooling using cooling water or a refrigerator such that the volatile substance condenses on a heat exchanger surface, flows down from it and can be removed. Alternatively or in addition to cooling the condensation can be implemented by increasing the pressure.

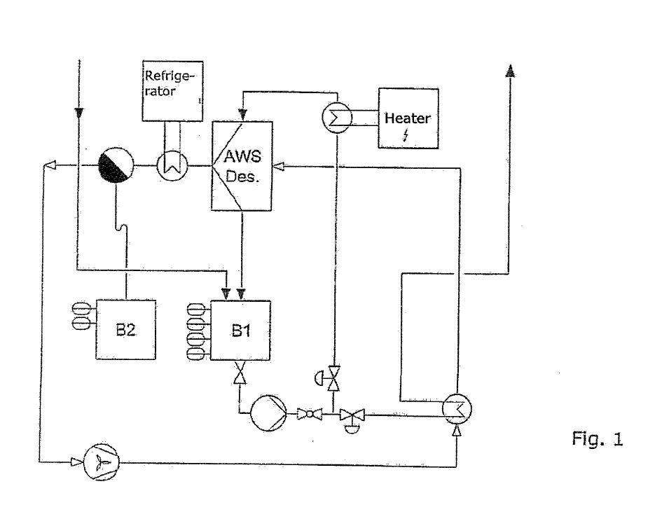

Referring to FIG. 1, an example of a solvent recovery system is described below. Genosorb® 1843 (triethylene glycol dibutylether) with 1.23% butyl acetate from a solvent separation system is supplied at a temperature of 70° as liquid mixture (absorbent with volatile substances) to a desorber unit (AWS Des.) comprising an active volume of 0.36 m³. Unloaded air is supplied in cross flow to the desorber unit by a fan. Thereby, about 8.1 g/s of butyl acetate can be transferred from the liquid phase to the gas phase, wherein the air is almost saturated. After this, the absorbent is supplied to the solvent separation system again. The loaded, heated air discharging from the desorber unit is supplied to an air heat exchanger as the condensation unit having an active volume of 0.18 m³, in which the butyl acetate is condensed from the gas phase at a temperature of 5° C. and discharged. The air discharging from the condensation unit only comprises a load of 0.51% and is supplied to the desorber unit again.

1. Device for removing at least one volatile substance from a liquid mixture containing a liquid besides the at least one volatile substance, said device comprising:
a) a desorber unit comprising
a carrier arrangement with an inlet and an outlet for the liquid mixture, wherein the carrier arrangement is designed such that the liquid mixture can be guided between inlet and outlet via a plurality of carriers and form a flowing liquid film on the surface of the carriers,
a gas conduct with a gas inlet and a gas outlet, between which the gas can sweep past the liquid film, such that the at least one volatile substance can pass over from the liquid mixture into the gas,
b) a condensation unit with a gas inlet connected to the gas outlet of the desorber unit, a gas outlet connected to the gas inlet of the desorber unit, a heat exchanger for cooling gas passed through the same, which comes from the desorber unit, by means of a cooling medium, which can be passed through such that the at least one volatile substance can be condensed from the gas, and an outflow, through which the condensed, at least one volatile substance can flow out, and
c) a fan incorporated into a gas connection between the desorber unit and the condensation unit such that a gas stream through the device can be generated.

2. Device according to claim 1, wherein the carriers are porous woven plastic tubes.

3. Device according to claim 2, wherein the woven plastic tubes were subjected to a heat treatment for mechanical stabilization.

4. Device according to claim 1, wherein the gas is air.

5. Method for removing at least one volatile substance from a liquid mixture containing a liquid besides the at least one volatile substance, comprising the following steps:
guiding a gas past carriers moistened with the liquid mixture such that at least part of the at least one volatile substance passes over from the liquid mixture into the gas,
condensing the at least one liquid substance from the gas obtained in step a) by changing the pressure or the temperature of the obtained gas such that at least part of the at least one volatile substance is separated from the gas and the concentration of the at least one volatile substance is reduced in the gas, and
returning the gas obtained in step b) to step a).

6. Method according to claim 5, wherein the liquid mixture and the gas are guided in cross flow.

7. Method according to claim 5, wherein the gas is air.

8. The device according to claim 1, wherein the carriers are selected from the group consisting of profiles, tubes and pipes.

9. Device according to claim 2, wherein the gas is air.
